(19) United States
(12) Patent Application Publication
(10) Pub. No.: US 2025/0047754 A1
(43) Pub. Date: Feb. 6, 2025

(54) METHOD AND APPARATUS TO CREATE A VIRTUALIZED REPLICA OF A COMPUTER NETWORK

(71) Applicant: Extreme Networks, Inc., San Jose, CA (US)

(72) Inventors: Sumit GARG, Apex, NC (US); Donald B. GROSSER, Apex, NC (US); Jeffrey L. BARNHILL, Cary, NC (US); Gorden JENNINGS, Panama City, FL (US); Tony WANG, San Jose, CA (US); Yarnin ISRAEL, San Jose, CA (US); Shangquan WEN, San Jose, CA (US); Girish Kumar KARUNAGARAN, San Ramon, CA (US); Junjie MA, San Jose, CA (US)

(73) Assignee: Extreme Networks, Inc., San Jose, CA (US)

(21) Appl. No.: 18/362,259

(22) Filed: Jul. 31, 2023

(51) Int. Cl. H04L 67/51; H04L 67/1061

(52) U.S. Cl. CPC H04L 67/51; H04L 67/1061

(57) ABSTRACT

Disclosed herein are system, method, and computer program product embodiments for generating a virtual replica of a physical network device and/or a physical network. An aspect operates by receiving, from a network management system (NMS), a request to generate a device digital twin (device-DT) instance corresponding to a physical network device, where the request includes at least a first plurality and a second plurality of device characteristics corresponding to the physical network device. A DT template is selected from a plurality of DT templates based on the first plurality of device characteristics. The DT template is customized based on the second plurality of device characteristics, and the device-DT instance of the physical network device is generated based on the customized DT template. Then a management channel is established between the device-DT instance and the NMS.

### BACKGROUND

Computer network management involves configuring, monitoring, updating, and troubleshooting network devices. Network management systems facilitate the centralized management of network devices, such as routers, switches, firewalls, and servers. They allow network administrators to configure and control network devices, manage updates, and enforce standardized configurations across the network.

Validating changes to a network, such as device configuration updates or the rollout of new applications and devices, prior to deployment is essential to reduce the risk of introducing disruptions or issues in the production network. However, modern networks can be highly complex, consisting of numerous devices, protocols, and interconnected systems. Validating configuration changes in such intricate environments can be challenging due to the sheer scale and interdependencies involved.

### SUMMARY

Some aspects of this disclosure relate to apparatuses and methods for creating a virtual replica of a computer network. For example, some aspects of this disclosure relate to using network device parameters and link connectivity information to customize a virtual-replica template and instantiate a digital twin instance of a physical network.

Some aspects of this disclosure relate to a network system with a memory and a processor coupled to the memory. The processor receives, from a network management system (NMS), a request to generate a device digital twin (device-DT) instance corresponding to a physical network device. According to some aspects, the request includes at least a first plurality and a second plurality of device characteristics corresponding to the physical network device. The processor then selects a virtual-replica template from a plurality of virtual-replica templates based on the first plurality of device characteristics and customizes the virtual-replica template based on the second plurality of device characteristics. The processor then generates the device-DT instance of the physical network device based on the customized virtual-replica template. A management channel is then established between the device-DT instance and the NMS.

According to some aspects, the processor receives, over the management channel, a request to modify configuration of the device-DT instance from the NMS. The processor then updates the configuration of the device-DT instance based on the request to modify configuration, and synchronizes the updated configuration of the device-DT instance and a running configuration of the physical network device using the management channel. According to some aspects, the processor validates control plane, management plane, and data plane operations using the device-DT instance with the updated configuration.

According to some aspects, the first plurality of device characteristics include one or more of hardware attributes of the physical network device including device model, device serial number, media access control (MAC) address, device expansion module type, or stacking composition. According to some aspects, the second plurality of device characteristics include a running configuration of the physical network device, where the running configuration includes one or more of software attributes including network operating system type, network operating system version, or feature licenses. According to some aspects, the second plurality of device characteristics include network connectivity information learned by the physical network device through network discovery. According to some aspects, each virtual-replica template of the plurality of virtual-replica templates defines a superset of hardware and software attributes corresponding to a respective type of network device.

Some aspects of this disclosure relate to a method for generating a device digital twin (device-DT) instance corresponding to a physical network device. According to some aspects, the method includes receiving, from a network management system (NMS), a request to generate the device digital twin (device-DT) instance corresponding to the physical network device, where the request includes at least a first plurality and a second plurality of device characteristics corresponding to the physical network device. The method also includes selecting a virtual-replica template from a plurality of virtual-replica templates based on the first plurality of device characteristics, and customizing the virtual-replica template based on the second plurality of device characteristics. The method further includes generating the device-DT instance of the physical network device based on the customized virtualized-replica template, and establishing a management channel between the device-DT instance and the NMS.

Some aspects of this disclosure relate to a non-transitory computer-readable medium (CRM) having instructions stored thereon that, when executed by at least one computing device, causes the at least one computing device to perform various operations. According to some aspects, the operations include receiving, from a network management system (NMS), a request to generate a device digital twin (device-DT) instance corresponding to a physical network device, where the request includes at least a first plurality and a second plurality of device characteristics corresponding to the physical network device. The operations further include selecting a virtual-replica template from a plurality of virtual-replica templates based on the first plurality of device characteristics, and customizing the virtual-replica template based on the second plurality of device characteristics. The operations further include generating the device-DT instance of the physical network device based on the customized virtualized-replica template, and establishing a management channel between the device-DT instance and the NMS.

According to some aspects of this disclosure, the processor receives, from a NMS, a request to generate a network digital twin (network-DT) instance corresponding to a physical network including a plurality of physical network devices. According to some aspects, the request includes link connectivity information corresponding to the physical network and a respective plurality of device characteristics corresponding to each of the plurality of physical network devices. The processor then generates a plurality of device digital twin (device-DT) instances, each corresponding to a respective physical network device of the plurality of physical network devices, where each device-DT instance of the plurality of device-DT instances is generated based on the respective plurality of device characteristics corresponding to the respective physical network device. The processor then generates the network-DT instance based on the plurality of device-DT instances and the link connectivity information, and a management channel is established between the network-DT instance and the NMS.

According to some aspects, the processor receives, over the management channel, a request to modify configuration of the network-DT from the NMS, where the request to modify configuration includes a set of modified configuration parameters. The processor then updates the configuration of the network-DT instance based on the modified configuration parameters, and synchronizes the updated configuration of the network-DT instance and a running configuration of the physical network device using the management channel. According to some aspects, the processor validates control plane, management plane, and data plane operations using the network-DT with the updated configuration.

According to some aspects, to generate a device-DT instance of the plurality of device-DT instances the processor selects a virtual-replica template from a plurality of virtual-replica templates based on a first plurality of device characteristics of the respective plurality of device characteristics. The processor then customizes the virtual-replica template based on the second plurality of device characteristic of the respective plurality of device characteristics, and generates the device-DT instance of the physical network device based on the customized virtualized-replica template.

Some aspects of this disclosure relate to a non-transitory computer-readable medium (CRM) having instructions stored thereon that, when executed by at least one computing device, causes the at least one computing device to perform various operations. According to some aspects, the operations include receiving a request to generate a network digital twin (network-DT) instance corresponding to a physical network including a plurality of physical network devices, where the request includes link connectivity information corresponding to the physical network and a respective plurality of device characteristics corresponding to each of the plurality of physical network devices. The operations further include generating a plurality of device digital twin (device-DT) instances each corresponding to a respective physical network device of the plurality of physical network devices, where each device-DT instance of the plurality of device-DT instances is generated based on the respective plurality of device characteristics corresponding to the respective physical network device. The operations further include generating the network-DT instance based on the plurality of device-DT instances and the link connectivity information, and establishing a management channel between the network-DT instance and the NMS.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example network system for generating a virtualized replica of a computer network, according to some aspects of the disclosure.

FIG. 2 illustrates an example exchange of communications that may occur in a network system to create a digital twin of a network device, according to some aspects of the disclosure.

FIG. 3 illustrates an example exchange of communications that may occur for synchronizing configuration changes between a device digital twin and a corresponding physical network device, according to some aspects of this disclosure.

FIG. 4 illustrates an exemplary method to generate a device digital twin instance of a physical network device, according to some aspects of this disclosure.

FIG. 5 illustrates an exemplary method to generate a network digital twin instance of a physical network, according to some aspects of this disclosure.

FIG. 6 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for creating a virtual replica of a computer network. For example, embodiments herein describe generating a digital twin (DT) instance of a network device on a cloud network and/or generating a DT instance of a network (e.g., a computer network) on the cloud network.

Validating network and configuration changes prior to deployment reduces the risk of introducing disruptions at runtime. A physical sandbox environment can be used for validating the effectiveness of upgrades, such as new hardware, software updates, or configuration changes, and verifying their impact on network performance. A sandbox network is a separate and isolated network environment that closely resembles the production network but is used specifically for testing and troubleshooting.

The sandbox network should mirror the production environment as closely as possible to ensure accurate network testing and validation. Creating a replica of the production network in the sandbox environment involves setting up similar network devices, servers, applications, and connectivity configurations. In addition, existing network device configurations also should be replicated from the production environment. However, duplicating network devices to create a physical sandbox network that resembles the production network can be an arduous and time-consuming process.

To solve the above technological problem, aspects of this disclosure describe creating a DT instance of a physical network (herein referred to as “network-DT”) that provides cost-effective network configuration assurance and network modeling. Furthermore, the network-DT includes multiple device-DTs, where each device-DT is a DT instance corresponding to a network device of the physical network. According to some aspects, the network-DT and/or the device-DT can be created automatically with no (or minimum) involvement from a user (e.g., a network administrator).

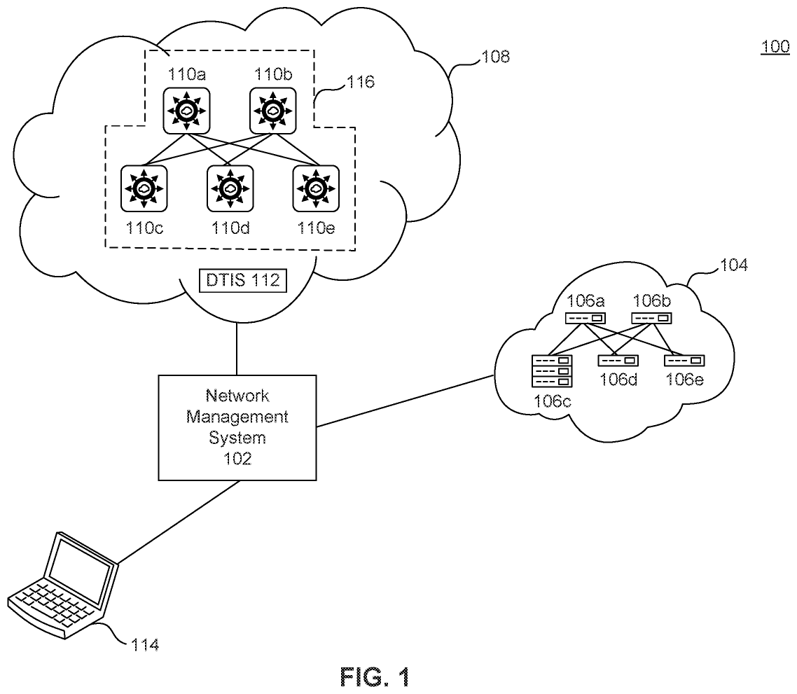

FIG. 1 illustrates an example network system 100 for generating a virtualized replica of a computer network, according to some aspects of this disclosure. Network system 100 includes network management system (NMS) 102, physical network 104, virtual cloud network 108, and client device 114. Physical network 104 includes one or more physical network devices 106a-106e. Furthermore, virtual cloud network 108 includes network digital twin (network-DT) 116 that is a virtual replica of physical network 104. Network-DT 116 includes one or more device digital twins (device-DTs) 110a-110e. According to some aspects, each of the device-DTs 110a-110e is a virtual replica of one of the physical network devices 106a-106e. However, a device-DT may also be a virtual replica of more than one physical network device 106a-106e (e.g., two or more network switches in a stacked configuration).

According to some aspects, each of the physical network devices 106a-106e may be a router, switch, bridge, network gateway, server, host and/or the like. According to some aspects, hardware attributes of a physical network device 106a-106e may include model name, serial number, MAC addresses, device expansion module type, interface module type, stacking composition, and the like. According to some aspects, software attributes of a physical network device 106a-106e may include network operating system (NOS) type, NOS version, feature license(s), and the like. Furthermore, each physical network device 106a-106e may be configured with a plurality of configuration parameters that include virtual local area network (VLAN) parameters, spanning tree protocol (STP) parameters, open shortest path first (OSPF) parameters, fabric parameters, virtual router redundancy protocol (VRRP) parameters, and the like.

According to some aspects, network-DT 116 may be implemented by, for example, a data center including one or more servers in the cloud. According to some aspects, cloud network 108 may include one or more physical devices and/or one or more applications hosted on a distributed computing platform, a cloud computing platform, a centralized hardware system, a server, a computing device, and/or an external network-to-network interface device, among others.

According to some aspects, device-DTs 110a-110e of network-DT 116 are virtual replicas of physical network devices 106a-106e. Hence, the hardware attributes, the software attributes, and the device configuration of a device-DT and its corresponding physical network device may be identical. According to some aspects, device-DTs 110a-110e and physical network devices 106a-106e are configured with the same network operating system (NOS). According to some aspects, device-DTs 110a-110e are configured with virtualized NOS instantiated in cloud network 108.

According to some aspects, network-DT 116 is a virtualized replica of the physical network 104. Accordingly, the configuration of interconnections between device-DTs 110a-110e mirrors the configuration of interconnections between physical network devices 106a-106e. Since network-DT 116 mirrors the characteristics of physical network 104, network-DT 116 provides a sandbox environment to validate the management plane, control plane, and data plane features of physical network 104. According to some aspects, the use cases for which network-DT 116 can be utilized include, but are not limited to, validating new configuration and/or new features, validating software upgrades for devices in the network, scaled feature/device validations, agile customer demonstrations including various solution components, device/portfolio interoperability, network planning and best-practice applications, and the like. According to some aspects, network-DT 116 instance replicates a physical device and is capable of generating network traffic for validating changed configurations.

According to some aspects, NMS 102 manages the operation and function of physical network devices 106a-106e. According to some aspects, NMS 102 may be a cloud-based network management system. Client device 114 may communicate with NMS 102 using an application programming interface (API) to configure and manage physical network devices 106a-106e and/or device-DTs 110a-110e. Alternatively or additionally, NMS 102 may communicate with the physical network devices 106a-106e using a wired link (e.g., coaxial cable, Ethernet cable, fiber optic cable, etc.), a wireless link and/or combinations thereof. According to some aspects, NMS 102 can be deployed as an on-premise solution (i.e., without deploying on an external cloud network). According to some aspects, NMS 102 may automate the management of physical network devices 106a-106e and/or device-DTs 110a-110e using a software defined networking (SDN) controller. According to some aspects, client device 114 may access NMS 102 via a password protected user interface. According to some aspects, NMS 102 may provide access to devices remotely using secure shell (SSH), secure socket layer (SSL)/transport layer security (TLS) protocols. According to some aspects, NMS 102 may support simple network management protocol (SNMP) protocol.

Furthermore, NMS 102 may support full-stack management of physical network devices 106a-106e and enable management operations such as onboarding, configuration, monitoring, troubleshooting, reporting, and the like. According to some aspects, a user can set up a network by onboarding physical network devices 106a-106e onto the NMS 102. Using NMS 102, the user can configure and manage the network devices 106a-106e. As an example, users can define global settings, view device status, and customize device configurations at the device level. According to some aspects, using NMS 102, users can assign devices to an existing user-defined location tree within the context of NMS 102.

According to some aspects, digital twin instantiation service (DTIS) 112 performs a variety of functions such as instantiating, updating, life-cycle management, and deleting DTs. According to some aspects, DTIS 112 communicates with NMS 102 to exchange device characteristic and interconnectivity configuration corresponding to physical network devices 106a-106e. According to some aspects, in case a DT-device goes into erroneous state, DTIS 112 is responsible of recovering the DT-device either by shutting it down and relaunch it, or recreate a whole new instance with the same configuration. According to some aspects, when a DT-device goes into erroneous state, DTIS 112 recreates a new DT-device instance using a saved bundled configuration and/or a preserved disk from the previous instance. DTIS 112 can be implemented on virtual cloud network 108. However, DTIS 112 can be co-located with NMS 102, according to some aspects.

According to some aspects, DTIS 112 maintains instances of virtualized NOS and virtual-replica templates. According to some aspects, DTIS 112 may store a plurality of virtual-replica templates corresponding to various types of physical network devices, such as routers, switches, bridges, network gateways, servers, hosts, and the like. According to some aspects, a virtual-replica template may define a superset of hardware and software attributes corresponding to a respective type of network device. For each type of physical network device, DTIS 112 may maintain a configurable virtual-replica template that can be configured based on a variety of hardware and software attributes. According to some aspects, a virtual-replica template can be configured and instantiated to generate a virtual replica of a corresponding physical network device

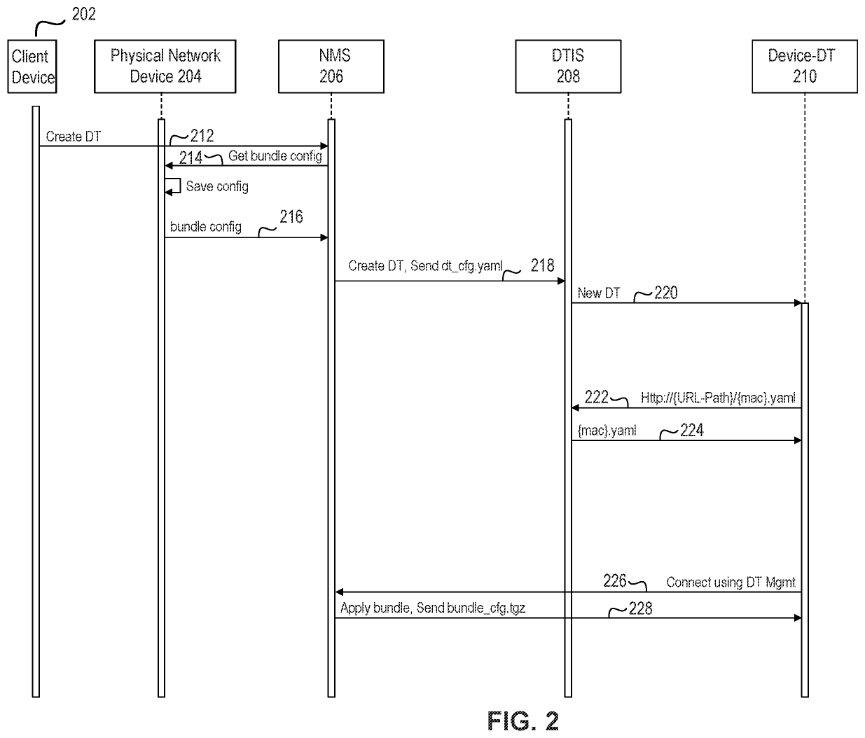

FIG. 2 illustrates an example exchange of communications that may occur in a network system to create a digital twin of a network device, according to some aspects of this disclosure. In the illustrated example, the network system 200 includes a client device 202, physical network device 204, NMS 206, DTIS 208, and device-DT 210.

At 212, client device 202 initiates creating a digital twin instance using a user interface of NMS 206. According to some aspects, client device 202 sends a request to NMS 206 to create a DT instance of physical network device 204 on a cloud network (e.g., virtual cloud network 108). In the example of FIG. 2, device-DT 210 is the DT instance of physical network device 204. According to some aspects, client device 202 (which can be client device 114 of FIG. 1) may communicate with NMS 206 (which can be NMS 102 of FIG. 1) using an application programming interface (API). The request to generate a DT instance corresponding to a physical network device or physical network 104 may be sent as a REST API call.

According to some aspects, NMS 206 displays a list of managed devices, and the user of client device 202 selects the physical network device 204 to generate a corresponding device-DT 210. According to some aspects, a user may select physical network device 204 based on a serial number and/or a model number. Additionally, the user may make a selection based on an OS persona, device model, and OS version of the physical network device 204.

At 214, NMS 206 sends a request to physical device 204 to send details corresponding to its running configuration. According to some aspects, NMS 206 communicates with physical network device 204 using SSH, SSL/TLS, and/or SNMP protocols. According to some aspects, NMS 206 may send a <get> or a <get-config> remote procedure call (RPC) message to obtain a configuration bundle from the physical network device 204. However, the aspects of this disclosure are not limited to these examples and can include other requests.

At 216, physical device 204 generates a bundle of its current configuration and/or its operating system characteristics, and sends it to NMS 206. According to some aspects, since NMS 206 actively manages the physical network device 204, it may have information corresponding to the hardware and software attributes of network device 204.

At 218, NMS 206 sends a request to DTIS 208 to create a DT instance of network device 204. According to some aspects, NMS 206 sends a request to DTIS 208 using a REST API call or a gRPC (gRPC remote procedure call). According to some aspects, the request to DTIS 208 includes a plurality of device characteristics corresponding to the physical network device 204. According to some aspects, the request may include hardware attributes of physical network device 204. Alternatively, the request may include both hardware attributes and software attributes of physical device 204. According to some aspects, the request may include hardware attributes of physical network device 204, such as model name, serial number, MAC addresses, device expansion module type, interface module type, stacking composition, and the like. According to some aspects, the request may include software attributes of physical network device 204 such as NOS type, NOS version, feature license(s), and the like. Furthermore, the request includes the running configuration of physical each physical network device and/or configuration parameters such as VLAN parameters, STP parameters, OSPF parameters, fabric parameters, VRRP parameters, and the like.

According to some aspects, at 218, NMS 206 sends information corresponding to device characteristics, including link connectivity information. According to some aspects, the link connectivity information may be obtained by NMS 206 by receiving layer 2 and layer 3 connectivity information that physical network devices 204 (e.g., the physical network devices 106a-106b of FIG. 1) may learn through network discovery. According to some aspects, physical network devices 106a-106b may obtain link connectivity information using traceroute, simple network management protocol (SNMP) and/or link layer discovery protocol (LLDP).

At 220, DTIS 208 initiates the instantiation of digital twin 210. According to some aspects, DTIS 208 may store a plurality of virtual-replica templates corresponding to various types of physical network devices. According to some aspects, each virtual-replica template may correspond to a specific hardware model of a specific type of physical network device (e.g. a specific model of a network switch). In addition, each virtual-replica template may define a superset of hardware and software attributes corresponding to a respective type of network device. In some aspects, DTIS 208 and digital twin 210 can be collocated (e.g., initially) on a same cloud network.

According to some aspects, at 220, DTIS 208 may select a virtual-replica template based on one or more hardware characteristics of physical network device 204. DTIS 208 may further customize the selected virtual-replica template based on one or more software characteristics and/or hardware characteristics of physical network device 204. DTIS 208 may then instantiate the customized virtual-replica template to generate device-DT 210. According to some aspects, the hardware characteristics based on which DTIS 208 selects and/or customizes a virtual-replica template may include, but are not limited to, model name, serial number, MAC addresses, device expansion module type, interface module type, and stacking composition. According to some aspects, the software characteristics based on which DTIS 208 customizes a virtual-replica template may include, but are not limited to, NOS type, NOS version, feature licenses, VLAN parameters, STP parameters, OSPF parameters, fabric parameters, VRRP parameters, and the like.

At 222, device-DT 210 instance requests additional device characteristics information from DTIS 208. According to some aspects, at 222, a based version of device-DT 210 may request additional hardware and/or software characteristics corresponding to physical network device 204. According to some aspects, device-DT 210 instance may send a <get> RPC message to obtain device characteristics information from DTIS 208.

At 224, DTIS 208 sends additional hardware and/or software characteristics corresponding to physical network device 204. Device-DT 210 may be further customized based on the received hardware and/or software characteristics. According to some aspects, NMS 206 and/or DTIS 208 may create a DT management channel between NMS 206 and device-DT 210, via DTIS 208. According to some aspects, the management channel can be established using SSH or SSL/TSL protocols.

At 226, device-DT 210 sends a request to NMS 206 to send information corresponding to current running configuration of physical network device 204. Device-DT 210 may communicate with NMS 206 using the management channel. At 228, an updated configuration bundle is received from NMS 206, and device-DT 210 is further customized and/or updated based on the received running configuration parameters.

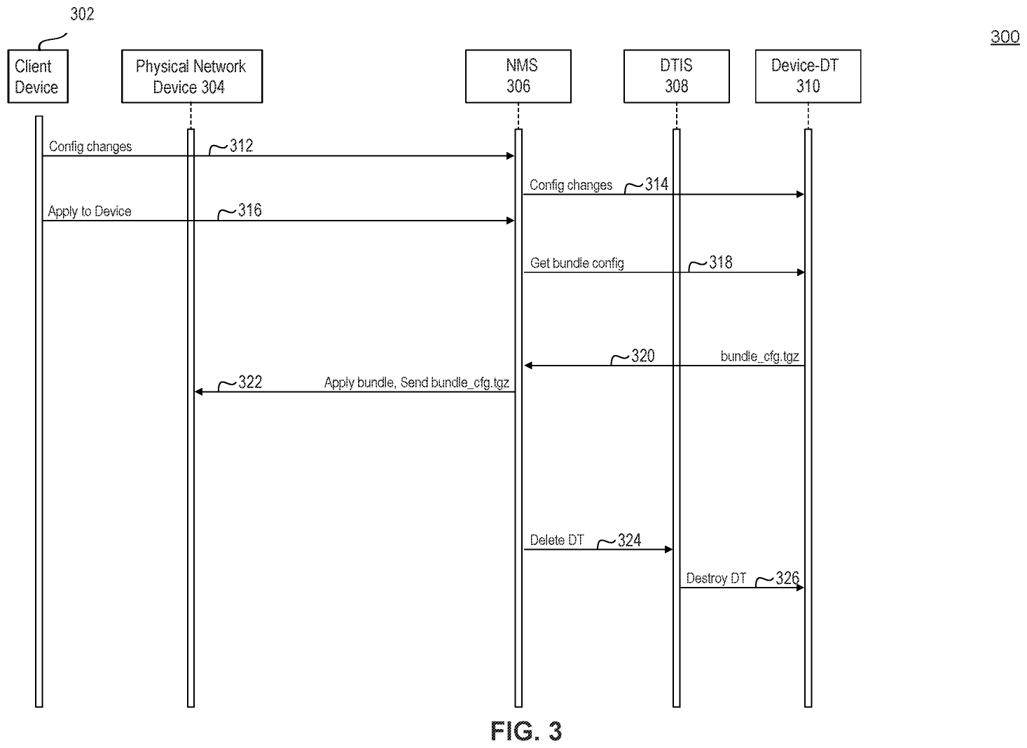

FIG. 3 illustrates an example exchange of communications that may occur for synchronizing configuration changes between a device digital twin and a corresponding physical network device, according to some aspects of this disclosure. In the illustrated example, the network system 300 includes a client device 302, physical network device 304, NMS 306, DTIS 308, and device-DT 310. Client device 302, physical network device 304, NMS 306, DTIS 308, and device-DT 310 can be the same as client device 202, physical network device 204, NMS 206, DTIS 208, and device-DT 210 of FIG. 2, respectively.

At 312, client device 302 sends a request to NMS 306 to initiate configuration changes to device-DT 310. According to some aspects, client device 302 may want to validate an updated configuration on device-DT 310 before implementing the updates at the physical network device 304. At 314, NMS 306 forwards the configuration change request to device-DT 310 using the management channel.

At 316, client device 302 provides NMS 306 with test configuration details for implementing and testing. At 318, NMS 306 forwards the test configuration bundle to device-DT 310 using the management channel. According to some aspects, device-DT 310 may update its configuration based on the received test configuration bundle. Furthermore, control plane, management plane, and/or data plane operations of physical network device 204 can be validated using device-DT 210 instance with the updated configuration. The test configuration that is debugged and/or validated using the device-DT 210 may subsequently be implemented at physical network device 304.

At 320, DTIS 308 initiates synchronization of the updated configuration of the device-DT instance and a running configuration of the physical network device. At 320, device-DT sends the validated test configuration bundle to NMS 306.

At 322, NMS 306 sends the validated test configuration to physical network device 304. The validated configuration is then applied at the physical network device 304. At 324, NMS 306 may send a request to DTIS 308 to delete the device-DT instance (e.g., device-DT 310) corresponding to the physical network device 304. At 326, the device-DT instance corresponding to the physical device 304 (e.g., device-DT 310) is destroyed, and the processing resources are released.

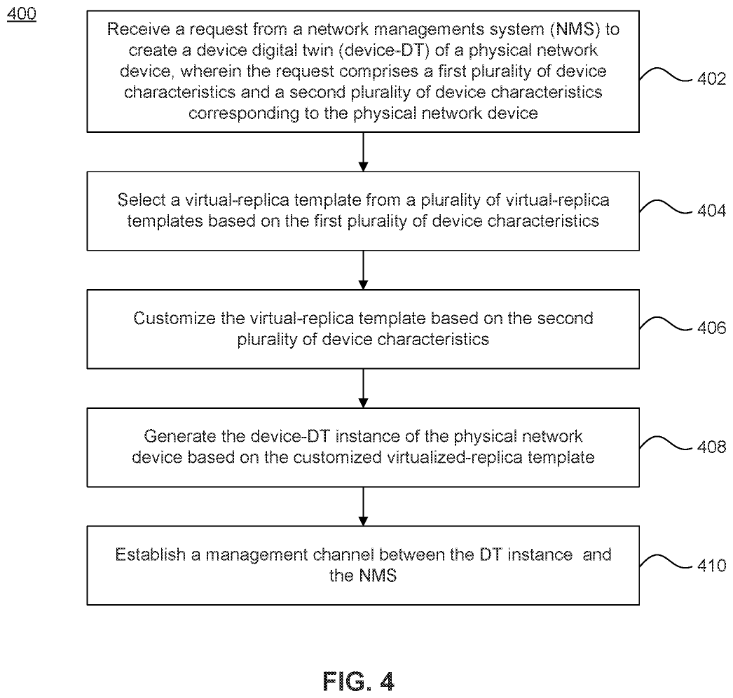

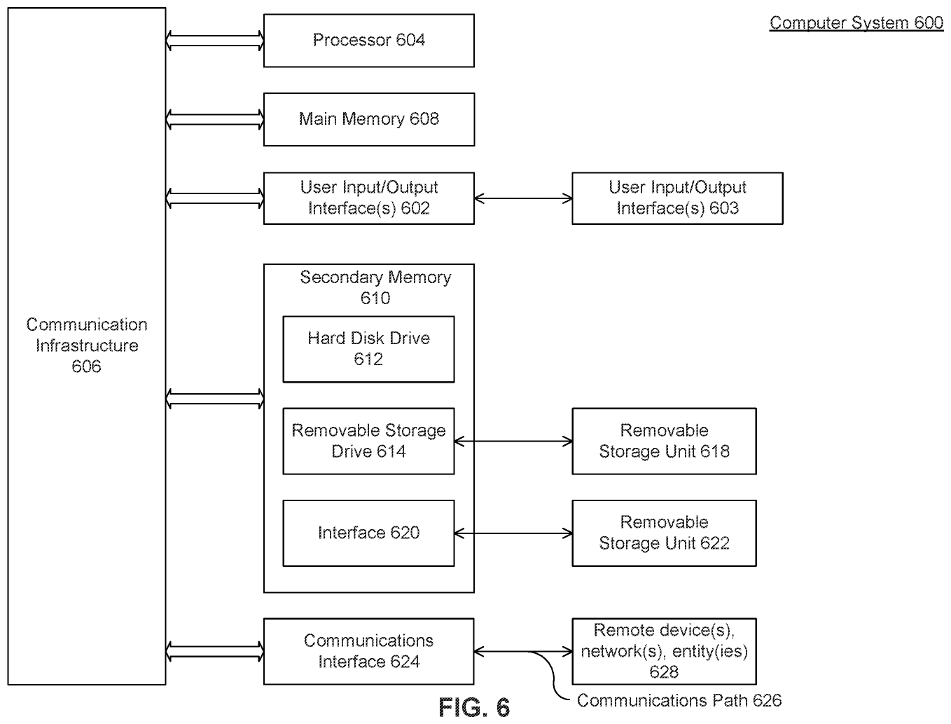

FIG. 4 is a conceptual diagram illustrating an exemplary method 400 to generate a device digital twin (device-DT) instance of a physical network device, according to some aspects of this disclosure. As a convenience and not a limitation, FIG. 4 may be described with regard to elements of FIGS. 1-3 and 6. Method 400 may be performed by, for example, digital twin instantiation service (DTIS) 112. Method 400 may also be performed by computer system 600 of FIG. 6. But method 400 is not limited to the specific aspects depicted in those figures, and other systems may be used to perform the method as will be understood by those skilled in the art. It is to be appreciated that not all operations may be needed, and the operations may not be performed in the same order as shown in FIG. 4.

At 402, a request to generate a device digital twin (device-DT) instance corresponding to a physical network device is received from a network management system (NMS). For example, the DTIS (e.g., DTIS 112) can receive the request to generate the device-DT instance corresponding to a physical network device. The request can include at least a first plurality and a second plurality of device characteristics corresponding to the physical network device. According to some aspects, the first plurality of device characteristics include one or more of the hardware attributes of the physical network device including device model, device serial number, media access control (MAC) address, device expansion module type, or stacking composition.

According to some aspects, DTIS 112 may store a plurality of virtual-replica templates corresponding to various types of physical network devices. Each virtual-replica template may define a superset of hardware and software attributes corresponding to a respective type of network device.

At 404, a virtual-replica template from a plurality of virtual-replica templates is selected based on the first plurality of device characteristics. For example, the DTIS (e.g., DTIS 112) selects the virtual-replica template from the plurality of virtual-replica templates. According to some aspects, the first plurality of device characteristics may include one or more of the hardware attributes of the physical network device including device model, device serial number, media access control (MAC) address, device expansion module type, interface module type, or stacking composition.

At 406, once a suitable virtual-replica template is selected based on the first plurality of device characteristics (e.g., the device model, the serial number, or the like), the virtual-replica template is customized based on the second plurality of device characteristics. For example, the DTIS (e.g., DTIS 112) customizes the virtual-replica template based on the second plurality of device characteristics. According to some aspects, the second plurality of device characteristics may include a running configuration of the physical network device, where the running configuration includes one or more software attributes including network operating system type, network operating system version, or feature licenses. Furthermore, the second plurality of device characteristics may include network connectivity information learned by the physical network device through network discovery.

At 408, the device-DT instance of the physical network device is generated based on the customized virtual-replica template. According to some aspects, DTIS 112 may be configured to instantiate the customized virtual-replica template to generate a virtual replica of the corresponding physical network device.

At 410, a management channel is established between the device-DT instance and the NMS. According to some aspects, the management channel is established, via the DTIS (e.g., DTIS 208), between the device-DT (e.g., device-DT 210) and the NMS (e.g., NMS 206). According to some aspects, a request to modify device-DT configuration may be received, by the DTIS, from the NMS receive over the management channel. According to some aspects, the configuration of the device-DT instance may be updated based on the request to modify configuration, and the updated configuration of the device-DT instance and a running configuration of the physical network device are synchronized using the management channel. According to some aspects, the control plane, management plane, and data plane operations of the physical network device may be validated using the device-DT with the updated configuration.

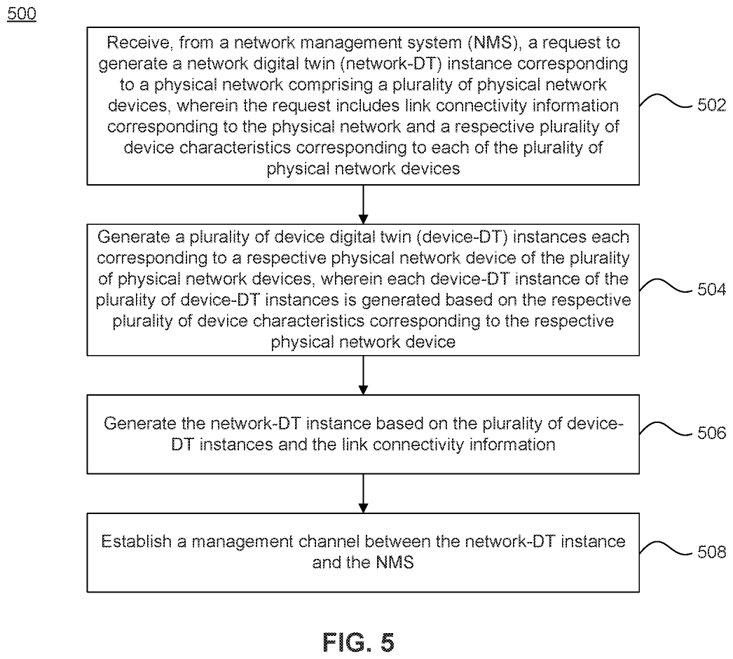

FIG. 5 is a conceptual diagram illustrating an exemplary method 500 to generate a network digital twin (network-DT) instance of a physical network, according to some aspects of this disclosure. As a convenience and not a limitation, FIG. 5 may be described with regard to elements of FIGS. 1-3 and 6. Method 500 may be performed by, for example, DTIS 112. Method 500 may also be performed by computer system 600 of FIG. 6. But method 500 is not limited to the specific aspects depicted in those figures, and other systems may be used to perform the method as will be understood by those skilled in the art. It is to be appreciated that not all operations may be needed, and the operations may not be performed in the same order as shown in FIG. 5.

At 502, a request to generate a network digital twin (network-DT) instance corresponding to a physical network including a plurality of physical network devices is received from a network management system (NMS). For example, the DTIS (e.g., DTIS 102) can receive the request to generate the network-DT instance. According to some aspects, the request includes link connectivity information corresponding to the physical network and a respective plurality of device characteristics corresponding to each of the plurality of physical network devices. Additionally, or alternatively, the DTIS (alone or in combination with the NMS) can determine the link connectivity information corresponding to the physical network and the respective plurality of device characteristics corresponding to each of the plurality of physical network devices from the physical network. For example, the DTIS (alone or in combination with the NMS) can “read” the link connectivity information and/or the respective plurality of device characteristics from the physical network. For example, the DTIS (alone or in combination with the NMS) can run an algorithm to “read” the link connectivity information and/or the respective plurality of device characteristics from the physical network.

At 504, a plurality of device digital twin (device-DT) instances, each corresponding to a respective physical network device of the plurality of physical network devices, are generated. For example, the DTIS can generate the device-DT instances. According to some aspects, each device-DT instance of the plurality of device-DT instances is generated based on the respective plurality of device characteristics corresponding to the respective physical network device.

According to some aspects, to generate a device-DT instance of the plurality of device-DT instances, the DTIS (e.g., DTIS 112) may select a virtual-replica template from a plurality of virtual-replica templates based on a first plurality of device characteristics of the respective plurality of device characteristics. DTIS 112 may then customize the virtual-replica template based on the second plurality of device characteristics of the respective plurality of device characteristics and generate the device-DT instance of the physical network device based on the customized virtualized-replica template.

At 506, the network-DT instance is generated based on the plurality of device-DT instances and the link connectivity information. According to some aspects, the link connectivity information may be obtained by the NMS (e.g., NMS 102) by receiving layer 2 and layer 3 connectivity information that the physical network devices (e.g., physical network devices 106a-106e) may learn through network discovery. According to some aspects, the physical network devices (e.g., physical network devices 106a-106e) may obtain link connectivity information using traceroute, simple network management protocol (SNMP) and/or link layer discovery protocol (LLDP).

At 508, a management channel between the network-DT instance and the NMS is established. According to some aspects, the management channel is established, via the DTIS (e.g., DTIS 112), between the network-DT (e.g., netwok-DT 116) and the NMS (e.g., NMS 102). According to some aspects, each of the individual DT-devices within the created network-DT instance have an established communication channel with NMS 102, via hyper text transfer protocol (HTTP), SSH, or RPC. According to some aspects, a request to modify the network-DT configuration may be received, by the DTIS, from the NMS receive over the management channel. According to some aspects, the configuration of the network-DT instance may be updated based on the request to modify the configuration, and the updated configuration of the network-DT instance and a running configuration of the physical network (e.g., physical network 104) are synchronized using the management channel. According to some aspects, the control plane, management plane, and data plane operations of the physical network 104 may be validated using the network-DT with the updated configuration.

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A system, comprising:
a memory;
a processor coupled to the memory and configured to:
receive, from a network management system (NMS), a request to generate a device digital twin (device-DT) instance corresponding to a physical network device, wherein the request includes at least a first plurality and a second plurality of device characteristics corresponding to the physical network device;
select a virtual-replica template from a plurality of virtual-replica templates based on the first plurality of device characteristics comprising hardware attributes of the physical network device, wherein the hardware attributes comprise a media access control (MAC) address and an interface module type corresponding to the physical network device;
customize the virtual-replica template based on the second plurality of device characteristics;
generate the device-DT instance of the physical network device based on the customized virtualized-replica template; and
establish a management channel between the device-DT instance and the NMS.

2. The system of claim 1, wherein the processor is further configured to:
receive, over the management channel, a request to modify configuration of the device-DT instance from the NMS;
update the configuration of the device-DT instance based on the request to modify configuration; and
synchronize, using the management channel, the updated configuration of the device-DT instance and a running configuration of the physical network device.

3. The system of claim 2, wherein the processor is further configured to:
validate control plane, management plane, and data plane operations using the device-DT instance with the updated configuration.

4. The system of claim 1, wherein the hardware attributes of the physical network device further comprise one or more of device serial number, device model, device expansion module type, or stacking composition.

5. The system of claim 1, wherein the second plurality of device characteristics comprise a running configuration of the physical network device, wherein the running configuration comprises one or more of software attributes comprising network operating system type, network operating system version, or feature licenses.

6. The system of claim 1, wherein the second plurality of device characteristics comprise network connectivity information learned by the physical network device through network discovery.

7. The system of claim 1, wherein each virtual-replica template of the plurality of virtual-replica templates defines a superset of hardware and software attributes corresponding to a respective type of network device.

8. A method for generating a device digital twin (device-DT) instance corresponding to a physical network device, the method comprising:
receiving, from a network management system (NMS), a request to generate the device digital twin (device-DT) instance corresponding to the physical network device, wherein the request includes at least a first plurality and a second plurality of device characteristics corresponding to the physical network device;
selecting a virtual-replica template from a plurality of virtual-replica templates based on the first plurality of device characteristics comprising hardware attributes of the physical network device, wherein the hardware attributes comprise a media access control (MAC) address and an interface module type corresponding to the physical network device;
customizing the virtual-replica template based on the second plurality of device characteristics;
generating the device-DT instance of the physical network device based on the customized virtualized-replica template; and
establishing a management channel between the device-DT instance and the NMS.

9. The method of claim 8, further comprising:
receiving, over the management channel, a request to modify configuration of the device-DT instance from the NMS;
updating the configuration of the device-DT instance based on the request to modify configuration; and
synchronizing, using the management channel, the updated configuration of the device-DT instance and a running configuration of the physical network device.

10. The method of claim 8, further comprising:
validating control plane, management plane, and data plane operations using the device-DT instance with the updated configuration.

11. The method of claim 8, wherein the hardware attributes of the physical network device further comprise one or more of device serial number, device model, device expansion module type, or stacking composition.

12. The method of claim 8, wherein the second plurality of device characteristics comprise a running configuration of the physical network device, wherein the running configuration comprises one or more of software attributes comprising network operating system type, network operating system version, or feature licenses.

13. The method of claim 8, wherein the second plurality of device characteristics comprise network connectivity information learned by the physical network device through network discovery.

14. The method of claim 8, wherein each virtual-replica template of the plurality of virtual-replica templates defines a superset of hardware and software attributes corresponding to a respective type of network device.

15. A non-transitory computer-readable medium (CRM) having instructions stored thereon that, when executed by at least one computing device, causes the at least one computing device to perform operations comprising:
receiving, from a network management system (NMS), a request to generate a device digital twin (device-DT) instance corresponding to a physical network device, wherein the request includes at least a first plurality and a second plurality of device characteristics corresponding to the physical network device;
selecting a virtual-replica template from a plurality of virtual-replica templates based on the first plurality of device characteristics comprising hardware attributes of the physical network device, wherein the hardware attributes comprise a media access control (MAC) address and an interface module type corresponding to the physical network device;
customizing the virtual-replica template based on the second plurality of device characteristics;
generating the device-DT instance of the physical network device based on the customized virtualized-replica template; and
establishing a management channel between the device-DT instance and the NMS.

16. The non-transitory CRM of claim 15, the operations further comprising:
receiving, over the management channel, a request to modify configuration of the device-DT instance from the NMS;
updating the configuration of the device-DT instance based on the request to modify configuration; and
synchronizing, using the management channel, the updated configuration of the device-DT instance and a running configuration of the physical network device.

17. The non-transitory CRM of claim 15, the operations further comprising:
validating control plane, management plane, and data plane operations using the device-DT instance with the updated configuration.

18. The non-transitory CRM of claim 15, wherein the hardware attributes of the physical network device further comprise one or more of device serial number, device model, device expansion module type, or stacking composition.

19. The non-transitory CRM of claim 15, wherein the second plurality of device characteristics comprise a running configuration of the physical network device, wherein the running configuration comprises one or more of software attributes comprising network operating system type, network operating system version, or feature licenses.

20. (canceled)

21. The system of claim 1, wherein the second plurality of device characteristics comprise virtual local area network (VLAN) parameters corresponding to the physical network device.
